(19) United States
(12) Patent Application Publication
(10) Pub. No.: US 2003/0120697 A1
(43) Pub. Date: Jun. 26, 2003

(54) System and method for adapting a software control in an operating environment

(75) Inventors: Kenneth C. Wyke, Culpeper, VA (US); John Moore, Falls Church, VA (US); Archie Spivey, Myrtle Beach, SC (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Lockheed Martin Corporation

(21) Appl. No.: 10/321,388

(22) Filed: Dec. 18, 2002

Related U.S. Application Data
(60) Provisional application No. 60/341,862, filed on Dec. 21, 2001.

(51) Int. Cl. G06F 9/00

(52) U.S. Cl. 709/100

(57) ABSTRACT

A system and method for adapting a software control in an operating environment is disclosed. A control is placed within the operating environment and is adapted to be registered and recognized within the operating environment. A manager within the operating environment identifies the control. The manager also modifies the data structure of the control. The data structure includes data to interface within the operating environment and with other controls. Further, the control is recognizable within the operating environment.

### CROSS REFERENCE TO RELATED APPLICATIONS

This application claims benefit of U.S. Provisional Patent Application No. 60/341,862 entitled “Electronic Interactive Communication System and the Method Therefor,” filed Dec. 21, 2001, which is hereby incorporated by reference.

### BACKGROUND OF THE INVENTION

1. Field of the Invention

The present invention relates to an electronic interactive communication system, and, more particularly, the invention relates to a system and method for adapting a software control within an operating environment, wherein the control initially is not fully compatible with the operating environment and/or with the other controls within the operating environment.

2. Discussion of the Related Art

The number of computing platforms has markedly increased in recent years. Palm-size and/or portable computing devices have become commonplace. Further, the number of different versions of a particular platform has increased as well, each with specific operating systems. A variety of software programs also has been created to execute on the computing platforms. Conventional computing devices can pre-store information and program code in memory or receive the information from another device to enable executing the programs. With the multitude of computing platforms and operating systems, programs and information should be conceived with the ability to execute in many operating environments.

A software control may enable or launch different programs operating on different platforms. A software control may also be a program module that enhances the functionality of an existing program. A control may act as a user interface function that allows the user to manipulate information stored in the memory of a computing platform. Controls may add functionality by calling existing components to integrate and appear as normal parts of the program. In general, however, these controls are dormant until activated and may not reside passively within a computing environment. This drawback may reduce the effectiveness of the controls and restrict the ability of the controls to interact within the software environment, and with other programs and controls. Further, conventional controls may not access the properties and methods of other controls without causing that control to become active.

Controls may be desirable on computing platforms that are portable devices, as discussed above. The controls may improve the functionality of the portable device and provide the user with additional information over programs stored on the device. Problems, however, may occur if a control is placed within the operating environment and is not fully compatible with the operating environment or able to be recognized by the other controls. Errors or loss of functionality may occur. Further, security issues may arise if unregistered or unrecognized controls are allowed to execute within the operating environment.

### SUMMARY OF THE INVENTION

Accordingly, the disclosed embodiments are directed to a system and method for adapting a software control in an operating environment. A control is placed within the operating environment and adapted to be registered and recognized within the environment.

Additional features and advantages of the disclosed embodiments will be set forth in the description which follows, and in part will be apparent from the description, or may be learned by practice of the invention. The objectives and other advantages of the disclosed embodiments will be realized and attained by the structure particularly pointed out in the written description and claims hereof as well as the appended drawings.

To achieve these and other advantages and in accordance with the purpose of the present invention, as embodied and broadly described, a method for adapting a control within an operating environment is disclosed. The method includes identifying the control with a manager within the operating environment. The method also includes modifying a data structure of the control with data from the manager. The method also includes updating the operating environment with the control.

According to the disclosed embodiments, a system for adapting control within an operating environment is disclosed. The system includes a manager within the operating environment to identify the control. The system also includes a data structure to modify the control. The data structure is added to the control by the manager. The system also includes another control. The another control is updated by the manager according to the data structure.

According to the disclosed embodiments, a system for adapting a new control to an operating environment is disclosed. The system includes a manager within the operating environment. The new control initially is not recognized by the manager. The system also includes another control within the operating environment. The system also includes a data structure added to the new control. The manager and the another control interfaces with the new control via the data structure.

According to the disclosed embodiments, a method for adapting a control placed into an operating environment is disclosed. The method includes adding the control to the operating environment. The method also includes determining the control is unrecognizable by a manager within the operating environment. The method also includes adding a data structure to the control. The data structure comprises data to recognize the control within the operating environment. The method also includes updating other components within the operating environment to interface with the control.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates an operating environment having a control manager and controls in accordance with embodiments of the present invention.

FIG. 2 illustrates an adapted control within an operating environment in accordance with embodiments of the present invention.

FIG. 3 illustrates a flowchart for adapting a control within an operating environment in accordance with embodiments of the present invention.

### DETAILED DESCRIPTION OF THE PREFERRED EMBODIMENTS

Reference will now be made in detail to the preferred embodiments of the present invention, examples of which are illustrated in the accompanying drawings.

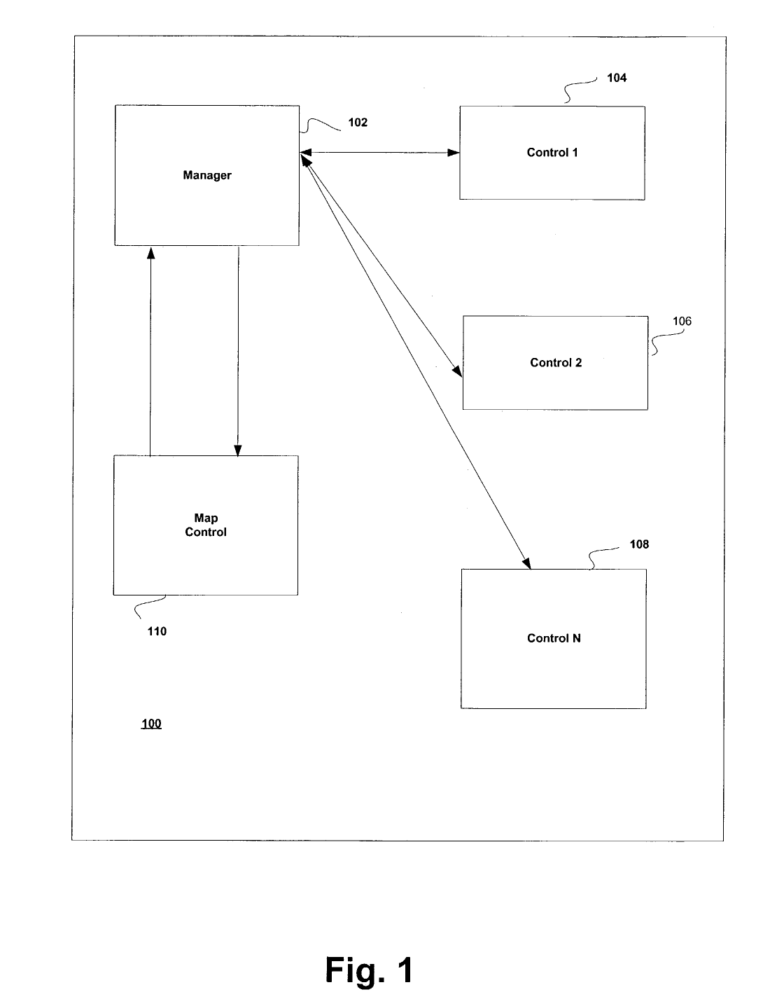

FIG. 1 depicts an operating environment 100 having a control manager 102 and controls 104, 106, and 108, and a map control 110 in accordance with embodiments of the present invention. Operating environment 100 may reside on any computing platform that includes a processor, memory, and software code, to execute instructions for operations on the platform. The computing platform also may be known as a unit or device that includes any computer, such as a desktop, a portable computer, a laptop, a personal digital assistant (“PDA”), and the like. The computing platform also may be a network of computers or other data exchange devices. Preferably, operating environment 100 resides on a portable computing device, such as a handheld computer that executes programs and applications.

The portable computing device may interact with a transmitter or other information storage resource to receive information that is of interest to the programs and applications on the device. Operating environment 100 may coordinate updates and data delivery to controls, programs and applications that are executing on the computing device.

Controls 104, 106, 108, and 110 may be different types to enhance programs and applications within operating environment 100. For example, map control 110 may provide functionality for displaying maps on the device. Further, control 104 may be a compass control, or the like. Control 104 also may be a mode control or a data control. Control 104 also may be an information control, a track data control, a tree control, or the like. Controls 104, 106, and 108, may act as user interfaces to manipulate data stored within a memory that is accessed by a software program within operating environment 100. For example, map control 110 may interact with a user to manipulate stored maps on a hand-held device.

The distinctive aspects of controls 104, 106, 108, and 110 includes their functionality as well as their specific structure (e.g., code). Controls 104, 106, 108 and 110 provide functions to components operating within operating environment 100. Thus, controls 104, 106, 108, and 110 are not limited in their functionality provided to operating environment 100 or the programs executing thereon. Further, the number of controls is not limited to controls 104, 106, 108 and 110. Operating environment 100 may include any number of controls, and is not limited to controls 104, 106, 108, and 110.

Operating environment 100 also includes a software control manager 102. Manager 102 recognizes and coordinates with controls 104, 106, 108, and 110 within operating environment 100. Controls 104, 106, 108, and 110 receive information through manager 102 from operating environment 100. This information may be received on the device hosting operating environment 100, and from programs and applications executing within operating environment 100. Manager 102 also facilitates communication between controls 104, 106, 108, and 110, or any other control recognized by manager 102. Manager 102 may be self-executable in that it may be launched automatically within operating environment 100. Manager 102 may not require a command to activate.

Manager 102 also recognizes controls that are introduced to operating environment 100, or are enabled by programs and applications executing within operating environment 100. For example, control 108 may contact manager 102 for a designation, or name, for use within operating environment 100. Control 108 may include a type string to designate the overall type of control. Manager 102 also may send a list of the controls to control 108 and their designations so that control 108 may exchange information with the other controls. Thus, within operating environment 100, controls may be aware of, and communicate with, each other.

For example, map control 110 resides within operating environment 100. Control 108 may be a compass control. Map control 110 may not need compass control 108, while compass control 108 may need map control 110 to be of any use to programs and applications within operating environment 100. If a user presses “North” on an interface provided by compass control 108, then compass control 108 would desire a map graphic to manipulate north. Subsequently, control 106 may be a macro control placed within operating environment 100. Control 106 may not be of immediate concern to map control 110, though map control 110 has been made aware of control 106 by manager 102.

Manager 102 facilitates the above-disclosed relationships by receiving the initial information about controls 110, 108, and 106, and ensuring that the controls are able to exchange information with each other. Further, manager 102 confirms that compass control 108 is dependent on map control 110. The sequence of placing controls 104, 106, 108, and 110 within operating environment 100 is not a significant factor as manager 102 controls access and coordination between the controls themselves and operating environment 100. Thus, controls 104, 106, 108, and 110 may be incorporated into operating environment 100 dynamically and automatically, and without the need to become “active” to be used by resident programs and applications.

Controls 104, 106, 108, and 110 may have certain properties that provide information to manager 102. The properties may be created according to a system design, and are indicated within the controls themselves. One property may be control type. A control type may be a data string, such as “Map” or “Compass,” that denotes the overall type of the control. This property allows manager 102 to identify the control against the other controls within operating environment 100. Another property may be support members. Support members may be a string that lists the other controls that the identified control may need (or alternatively wish) to use, such as compass control 108 disclosed above.

Manager 102 also may implement a security or confirmation process for controls that are placed within operating environment 100. Manager 102 may invoke the security process, when manager 102 identifies and registers a new control within operating environment 100. Manager 102 registers those controls that have authority and the data structure to reside within operating environment 100.

If manager 102 accepts the added control, then manager 102 retrieves information from the added control's data structure to facilitate communication with other controls, programs and applications within operating environment 100. For example, control 104 may remain passive within operating environment 100. If control 106 desires the functionality of control 104, then control 106 may receive the designation of control 104 from manager 102. Control 106 may store the designation within its own data structure, or may query manager 102 for control 104. Control 104, however, is not “launched” or made active in that it takes over the display or other components of the computing platform.

After the handshaking process, if the added control is not fully compatible or recognized by manager 102, then the added control may be adapted to operate within operating environment 100. For example, control 108 is added to operating environment 100. Manager 102 determines that control 108 is not compatible. Specifically, does assume that control 108 is not an e-Reusable Information Technology Environment (“eRITE”) control and does not have the data structure to support communication actions with manager 102. Thus, control 108 is modified to incorporate the data structure to be compatible with manager 102 and operating environment 100. This process may be called “wrapping” control 108. A wrapped control 108 may exist and interact within operating environment 100.

After being wrapped, control 108 may act as a recognized and compatible control within operating environment 100. Control 108 may receive a designation from manager 102 to allow other controls to access to control 108. Control 108 also may access other controls. Further, control 108 may be given a designation within a control list of manager 102. Control 108 may be identifiable like any eRITE control by manager 102, controls 104, 106, and 110, and operating environment 100.

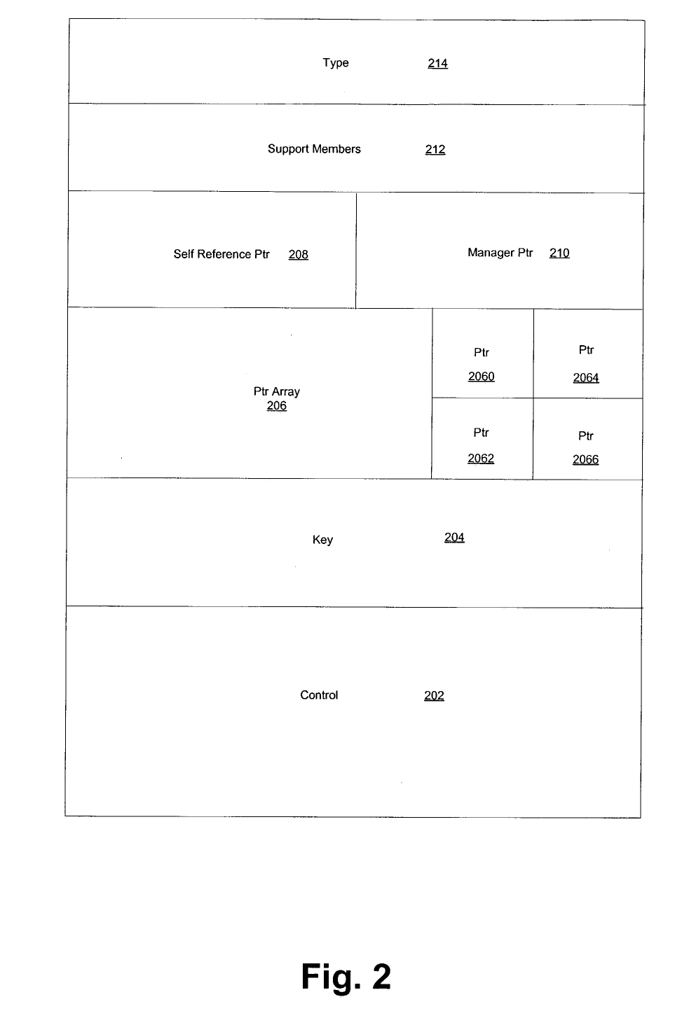

FIG. 2 depicts an adapted control 202 within an operating environment 200 in accordance with embodiments of the present invention. Control 202 has been modified to operate within operating environment, as disclosed above. Specifically, fields, strings, and other data may be appended to control 202 to facilitate operating within operating environment 200. A control manager, such as manager 102 of FIG. 1, may modify control 202.

Type string 214 may be added to control 202. Type string 214 may be a string that denotes the overall type of control 202. For example, type string 214 may identify control 202 as a map or compass control. Type string 214 allows a manager within operating environment 200 to identify control 202 amongst all the other controls within operating environment 200. Other controls may use type string 214 as the designation for control 202. Support members string 212 may be a comma-separated string that lists the other controls that control 202 may need to use in executing its functions. For example, if control 202 is a compass control, then a map control is listed within support members string 212 because a compass control is used to move the map control.

Self-reference pointer 208 may be a pointer to control 202 itself as it is viewed from the other controls within operating environment 200. Self-reference pointer 208 allows control 202 to manipulate some of its properties and functions that otherwise may not be accessible. Manager pointer 210 may be a pointer to the control manager, such as manager 102 in FIG. 1. Manager pointer 210 may be used when control 202 needs to access any of the exposed properties, functions, or methods of the control manager.

Pointer array 206 may be an array of pointers to the controls listed in support members string 212. The controls may exist within operating environment 200. For example, pointer array 206 may include pointer 2060, pointer 2062, pointer 2064, and pointer 2066. Each pointer correlates to a different control. Pointers 2060-2066 may be used when control 202 accesses the properties, functions, or methods of the listed controls, such as a pan method of a map control. Key string 204 may be a feature of a security scheme or process within operating environment 200. Key string 204 may used by a manager and control 202 to register control 202 within operating environment 200.

Additional fields, strings, pointers and data may be added to control 202. Methods to be executed by control 202 also may be implemented using the added data structure features disclosed above. By modifying control 202, operating environment 200 has enabled the functionality of control 202 to be more readily available to the other controls. For example, type string 214 allows control 202 to be referenced by the other controls and the control manager. Pointer array 206 allows control 202 to access other controls for their functionality. Thus, the functionality of control 202 is not lost due to incompatibility. Operating environment 200, in turn, provides more functionality and services than known operating environments because control 202 is adapted.

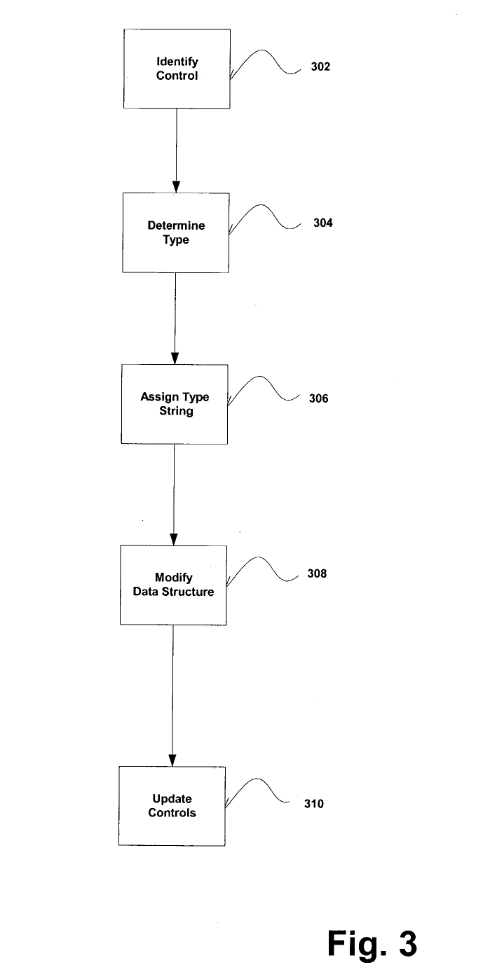

FIG. 3 depicts a flowchart for adapting a control within an operating environment in accordance with embodiments of the present invention. The flowchart depicts actions that an operating environment or control manager may perform in adapting a control to be compatible with other controls within the operating environment. Step 302 executes by identifying the control within the operating environment. The control is added or placed into the operating environment. Specifically, step 302 executes by identifying that the control is not compatible with the operating environment or a control manager. Identification of the control may occur using a security procedure implemented by the manager. Using the procedure, the manager may determine that the control is eligible to be adapted.

Step 304 executes by determining a type for the control. The control type may be elicited by querying the control, reading data from the control, receiving input from a user, or the like. The control type indicates the overall type of control for identification among all the controls. The control type may correlate to the functionality of the control, or the properties incorporated within the control. For example, the control type may be map or compass. Step 306 executes by assigning a type string to the control. The control manager may generate the type string. The type string indicates the control to the other controls and the operating environment.

Step 308 executes by modifying the data structure of the control to include the features disclosed with reference to FIG. 2. The manager may add the features to the control. The features may include data fields, strings, pointers, and the like. The data structure is modified to allow the control to be accessible by other controls. Further, the control now may access other controls via the added features. Step 310 executes by updating the other controls within the operating environment to reflect the addition of the control identified in step 302. For example, the pointer arrays within the other controls may be updated with a pointer to the identified control. Further, applicable support members strings may be updated with the new information for the control. Step 310 encompasses any methods, actions, processes, procedures, and the like performed in response to the steps disclosed above.

Thus, in accordance with the disclosed embodiments, a system and method for adapting a control within an operating environment is disclosed. A control may be placed within an operating environment and modified to operating within the operating environment. Controls that do not have a specific data structure may be adapted to interface with controls that have the specific data structure by modifying the control. The modified controls may include a type string, support members string, and a pointer array to interface with other controls. A control manager within the operating environment may provide the data and information needed to modify the control. Preferably, the control is modified to have an eRITE structure.

It will be apparent to those skilled in the art that various modifications and variations can be made in the wheel assembly of the present invention without departing from the spirit or scope of the invention. Thus, it is intended that the present invention covers the modifications and variations of this invention provided that they come within the scope of any claims and their equivalents.

What is claimed is:

1. A method for adapting a control within an operating environment, comprising:
identifying said control with a manager within said operating environment;
modifying a data structure of said control with data from said manager; and
updating said operating environment with said control.

2. The method of claim 1, further comprising assigning a type string to said control.

3. The method of claim 2, further comprising determining a type for said control.

4. The method of claim 1, wherein said modifying includes adding a type string to said data structure of said control.

5. The method of claim 1, wherein said modifying includes adding a key string to said data structure of said control.

6. The method of claim 1, wherein said modifying includes adding a support members string to said data structure of said control.

7. The method of claim 1, wherein said modifying includes adding a self-reference pointer to said data structure of said control.

8. The method of claim 1, wherein said modifying includes adding a manager pointer to said data structure of said control.

9. The method of claim 1, wherein said modifying includes adding a pointer array to said data structure of said control.

10. The method of claim 1, further comprising registering said control with said manager.

11. A system for adapting a control within an operating environment, comprising:
a manager within said operating environment to identify said control;
a data structure to modify said control, wherein said data structure is added to said control by said manager; and
another control, wherein said another control is updated by said manager according to said data structure.

12. The system of claim 11, wherein said data structure includes a type string.

13. The system of claim 11, wherein said data structure includes a pointer array to reference said another control.

14. The system of claim 11, wherein said data structure includes a self-reference pointer.

15. The system of claim 11, where said control is added to said operating environment.

16. The system of claim 11, wherein said manager references said control according to said data structure.

17. The system of claim 11, wherein said control provides a function to said operating environment.

18. A system for adapting a new control to an operating environment, comprising:
a manager within said operating environment, wherein said new control initially is not recognized by said manager;
another control within said operating environment; and
a data structure added to said new control, wherein said manager and said another control interfaces with said new control via said data structure.

19. The system of claim 18, wherein said data structure includes a type string.

20. The system of claim 18, wherein said data structure includes a pointer array.

21. The system of claim 18, wherein said operating environment associates data with said new control.

22. A method for adapting a control placed into an operating environment, comprising:
adding said control to said operating environment;
determining said control is unrecognizable by a manager within said operating environment;
adding a data structure to said control, wherein said data structure comprises data to recognize said control within said operating environment;
updating other components within said operating environment to interface with said control.

23. The method of claim 22, further comprising assigning a type string to said control, wherein said type string identifies said control within said operating environment.
